(19) United States
(12) Patent Application Publication
(10) Pub. No.: US 2018/0364439 A1
(43) Pub. Date: Dec. 20, 2018

(54) WAFER LEVEL INTEGRATED OPTICS IN PACKAGING FOR IMAGING SENSOR APPLICATION

(71) Applicant: OBSIDIAN SENSORS, INC., La Jolla, CA (US)

(72) Inventors: Yaoling PAN, San Diego, CA (US); Jian MA, San Diego, CA (US); John HONG, San Diego, CA (US); Tallis CHANG, San Diego, CA (US)

(73) Assignee: OBSIDIAN SENSORS, INC., La Jolla, CA (US)

(21) Appl. No.: 15/625,089

(22) Filed: Jun. 16, 2017

(51) Int. Cl. G02B 7/02; G02B 3/00; H04N 5/225

(52) U.S. Cl. CPC G02B 7/021; G02B 3/0062; H04N 5/2258; H04N 5/2257; H04N 5/2254

(57) ABSTRACT

Conventional optical lens assembly typically require a capping window, which is expensive, to protect the optical sensor. Also, each conventional optical lens assembly is discretely assembled, and thus incurs additional costs. To address these and other disadvantages, it is proposed to assemble a plurality of imaging sensors, a plurality of spacers, and a plurality of lenses at a panel. The resulting lens assembly array can be individualized into separate lens assemblies.

### FIELD OF DISCLOSURE

The field of the disclosed subject matter relates to optical packages. In particular, the field of the disclosed subject matter relates to wafer level integrated optics in packaging, e.g., for imaging sensor applications and to methods of manufacturing the same.

### BACKGROUND

One of the key challenging issues in commercialization of imaging sensors is the manufacturing cost. There are two major parts—packaging and optics—in imaging sensors that significantly contribute the total cost. High packaging cost is mainly due to the fact that high quality hermetic seal is often required for imaging sensors, in particular for thermal imaging sensors. In optics, mainly the-optical lens assembly, cost is driven by the high precision machining, special materials, as well as the discrete assembly processes. In the most instances, these two parts can be more than 60% of total cost, and sometime this can go as high as 80%.

FIG. 1A illustrates a conventional optical lens assembly 100A that includes a sensor module 150A on a substrate or a board 190 (e.g., a printed circuit board (PCB)), and an optical lens 120 above the sensor module 150A. The optical lens 120 is supported by housings 180 on the board 190. The sensor module 150A includes an optical sensor 110 packaged within a capping window 160 and a ceramic packaging 170. The capping window 160 and the ceramic packaging 170 are hermetically sealed so that the optical sensor 110 is protected.

The conventional optical lens assembly 100A is assembled discretely. That is, each sensor module 150A is individually made by packaging an individual optical sensor 110 within an individual capping window 160 and an individual ceramic packaging 170. The individually made sensor module 150A is assembled together with an individual lens 120 on the board 190 with the housings 180 to arrive at the optical lens assembly 100A. As indicated, such discrete assembly incurs high costs.

Also, the material for the capping window 160 can be costly. This is because the capping window 160 must often satisfy two requirements simultaneously. For the protection of the optical sensor 110, the capping window 160 should maintain high quality hermetic seal over a long period of time. For performance, the capping window 160 should allow maximum amount of light to pass through to reach the optical sensor 110. That is, the capping window 160 should have very low optical absorption. Materials satisfying both requirements can be expensive.

FIG. 1B illustrates another conventional optical lens assembly 100B that improves upon the conventional optical lens assembly 100A. The conventional optical lens assembly 100B includes a sensor module 150B on the board 190, and the optical lens 120 above the sensor module 150B supported by the housings 180. Unlike the sensor module 150A of FIG. 1A, the sensor module 150B of FIG. 1B includes the optical sensor 110 and the capping window 160, but does not include the ceramic packaging 170. The capping window 160 is hermetically sealed to the optical sensor 110.

The conventional optical lens assembly 100B improves upon the conventional optical lens assembly 100A in the following ways. First, cost is reduced since the ceramic packaging 170 is removed. Second, multiple optical sensors 110 and multiple capping windows 160 can be formed together at a wafer level and then diced. Therefore, the cost of the sensor module 150B can be lower than that of the sensor module 150A.

Unfortunately, the conventional optical lens assembly 100B itself is still discretely assembled. That is, the individually diced sensor module 150B is assembled together with the individual lens 120 on the board 190 with the housings 180 to arrive at the assembly 100B. Thus, there is still high cost associated with the conventional lens assembly 100B. In addition, the capping material can impact on the performance unless very low optical absorption materials used, which can be expensive, especially for long wavelength inferred radiation sensors.

### SUMMARY

This summary identifies features of some example aspects, and is not an exclusive or exhaustive description of the disclosed subject matter. Whether features or aspects are included in, or omitted from this Summary is not intended as indicative of relative importance of such features. Additional features and aspects are described, and will become apparent to persons skilled in the art upon reading the following detailed description and viewing the drawings that form a part thereof.

An exemplary lens assembly is disclosed. The lens assembly may comprise an imaging sensor, left and right spacers on the imaging sensor, and a lens on the left and right spacers. The left and right spacers may be spaced apart from each other. The lens, the left and right spacers, and the imaging sensor may define an interior space. The interior space may be hermetically sealed.

An exemplary method is disclosed. The method may comprise forming a lens assembly array; and individualizing the lens assembly array into a plurality of individual lens assemblies. After individualizing the lens assembly array, each lens assembly may comprise an imaging sensor, left and right spacers on the imaging sensor, and a lens on the left and right spacers. The left and right spacers may be spaced apart from each other. The lens, the left and right spacers, and the imaging sensor may define an interior space. The interior space may be hermetically sealed.

An exemplary lens assembly is disclosed. The lens assembly may comprise means for radiation sensing, left and right means for spacing on the means for radiation sensing, and a lens on the left and right means for spacing. The left and right means for spacing may be spaced apart from each other. The lens, the left and right means for spacing, and the means for radiation sensing may define an interior space. The interior space may be hermetically sealed.

### BRIEF DESCRIPTION OF THE DRAWINGS

The accompanying drawings are presented to aid in the description of examples of one or more aspects of the disclosed subject matter and are provided solely for illustration of the examples and not limitation thereof

FIGS. 1A and 1B illustrate examples of conventional optical lens assemblies;

FIG. 2A illustrates an example of a lens assembly array;

FIG. 2B illustrates an example of an individual lens assembly;

FIG. 3A illustrates an example of a spacer with getters;

FIG. 3B illustrates an example of an individual lens assembly that includes spacers with getters;

FIG. 4A illustrates an example of a lens assembly array with multiple lens levels;

FIG. 4B illustrates an example of an individual lens assembly with multiple lens levels;

FIGS. 5A-5H illustrate examples of different stages of fabricating a lens assembly array;

FIGS. 6A and 6B respectively illustrate top and side views of another example of a lens assembly array;

FIGS. 7A-7F illustrate examples of different stages of fabricating a lens assembly array of FIGS. 6A and 6B;

FIG. 8 illustrates a flow chart of an example method of fabricating a lens assembly;

FIG. 9 illustrates a flow chart of an example process of fabricating a lens assembly array;

FIG. 10 illustrates a flow chart of an example process of fabricating a lens array, fabricating a spacer array, attaching the lens array to the spacer array, and attaching the spacer array to an imaging sensor array; and

FIG. 11 illustrates examples of devices with a lens assembly integrated therein.

### DETAILED DESCRIPTION

Aspects of the subject matter are provided in the following description and related drawings directed to specific examples of the disclosed subject matter. Alternates may be devised without departing from the scope of the disclosed subject matter. Additionally, well-known elements will not be described in detail or will be omitted so as not to obscure the relevant details.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments of the disclosed subject matter include the discussed feature, advantage or mode of operation.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, processes, operations, elements, and/or components, but do not preclude the presence or addition of one or more other features, integers, processes, operations, elements, components, and/or groups thereof

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects may be embodied in a number of different forms, all of which have been contemplated to be within the scope of the claimed subject matter. In addition, for each of the examples described herein, the corresponding form of any such examples may be described herein as, for example, “logic configured to” perform the described action.

As indicated above, one of the key challenging issues facing commercialization of imaging sensors, especially for thermal imaging sensors, is the manufacturing cost. Many efforts have been pursued to save costs in the manufacturing of imaging sensors. For example, wafer level lens fabrication processes have been proven to be cost effective compared to the discrete lens fabrication processes.

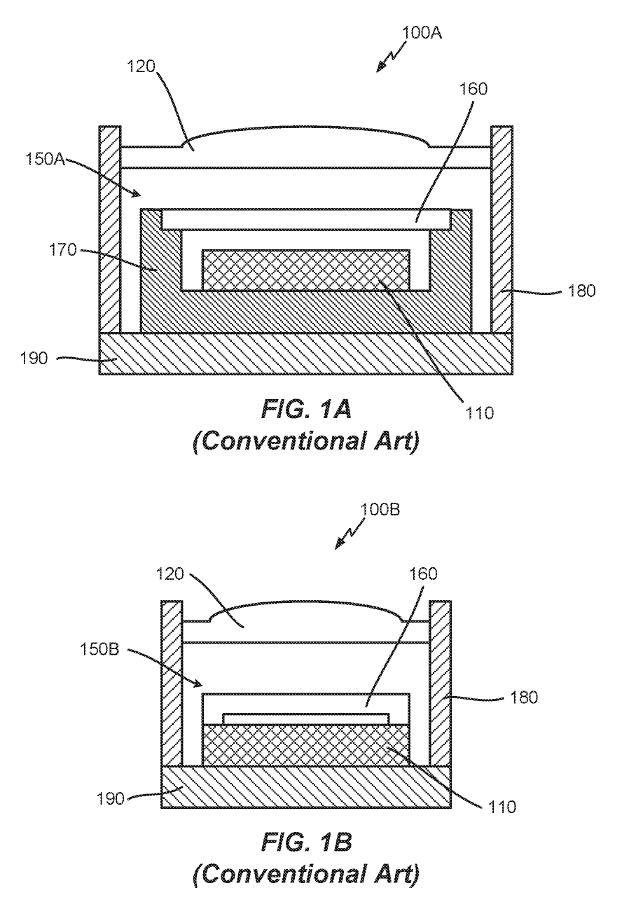

In a non-limiting aspect, a wafer level integrated optics in packaging (OiP) is proposed. Unlike the conventional lens assemblies 100A, 100B of FIGS. 1A and 1B, in the proposed OiP, multiple lens assemblies may be formed simultaneously, e.g., at a wafer level. Combining wafer level optics and wafer level packaging technologies allows advantages of low cost manufacturing processes in both technologies to be realized. In a non-limiting aspect, an integrated OiP may include some or all of the following attributes:
wafer level lens fabrication;
wafer level spacer fabrication;
wafer level assembly of optical system;
wafer level device seal with the optical lens system;
wafer level imaging sensor integration with the optical system;
scalable to large substrate size or panel.

In this disclosure, terms such as “upper”, “lower”, “top”, “bottom”, “left”, “right” and so on are used. Such terms are used merely for convenience, i.e., they should not be interpreted to be limiting.

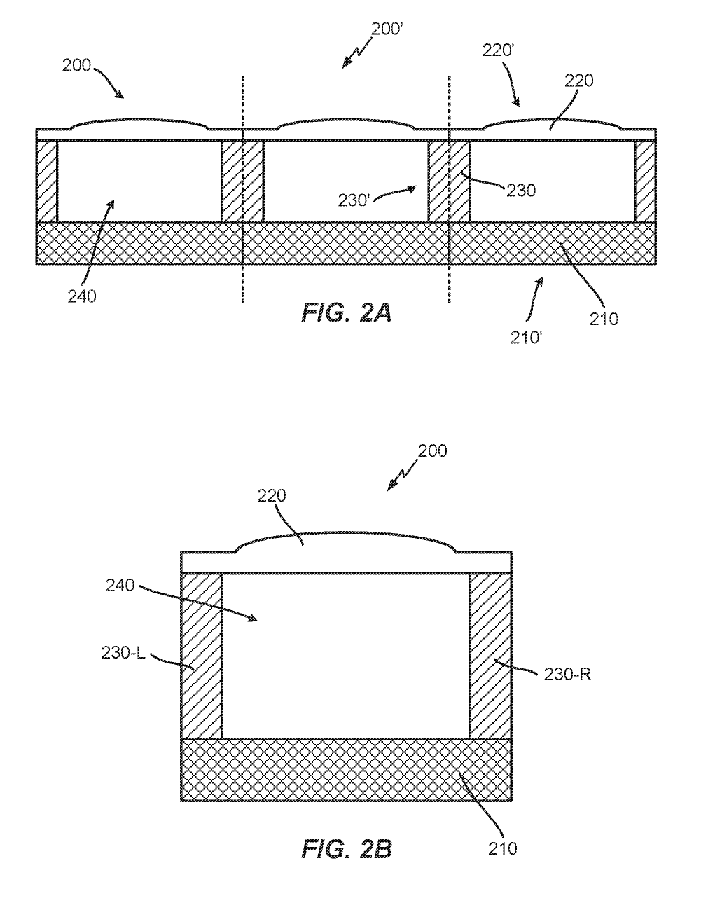

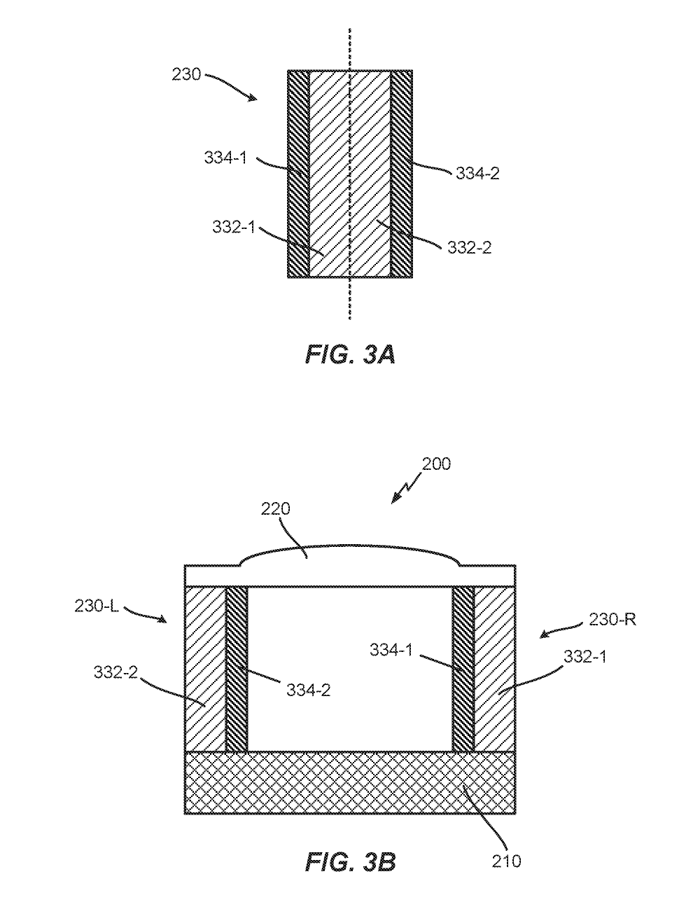

FIG. 2A illustrates an example of a lens assembly array 200′ which may comprise an imaging sensor array 210′, a spacer array 230′ on an upper surface of the imaging sensor array 210′, and a lens array 220′ on the spacer array 230′. The imaging sensor array 210′ may comprise a plurality of imaging sensors or sensing pixels 210, the spacer array 230′ may comprise a plurality of spacers 230, and the lens array 220′ may comprise a plurality of lenses 220.

FIG. 2B illustrates an example of an individual lens assembly 200, which may include an imaging sensor 210, left and right spacers 230-L, 230-R (collectively spacers 230) on an upper surface of the imaging sensor 210, and a lens 220 on the left and right spacers 230-L, 230-R. In an aspect, the individual lens assembly 200 may result from individualizing the lens assembly array 200′ of FIG. 2A along individualization lines (visualized as dashed lines). For example, the lens assembly array 200′ may be diced along the individualization lines. In an aspect, the lens assembly array 200′ may be viewed as comprising a plurality of lens assemblies 200.

The imaging sensor 210 may be an optical sensor, a thermal sensor, or a sensor that is sensitive to spectrum other than the visible and the infrared (IR). The imaging sensor 210 may be an example of means for radiation sensing. While not specifically shown, the imaging sensor 210 may include a sensor portion (e.g., focal plane array (FPA)) and a circuit portion (e.g., readout integrated circuit (ROTC)). In some aspects, the imaging sensor 210 may incorporate a substrate (e.g., glass, PCB) with the sensor and circuit portions on the substrate. The left spacer 230-L and the right spacer 230-R may comprise portions of adjacent spacers 230 of the spacer array 230′. The heights of the left and right spacers 230-L, 230-R may correspond to the focal length of the lens 220. The spacers 230-L and 230-R may each be examples of means for spacing.

Unlike the conventional optical lens assemblies 100A, 100B of FIGS. 1A, 1B, the lens assembly 200 of FIG. 2B does not include a capping window. As a result, cost can be reduced. Also a lower profile can be achieved since there is no need to accommodate the capping window. Further, performance can be enhanced since the radiation that would be absorbed by the capping window would reach the imaging sensor 210. Eliminating the capping window packaging process can simplify the manufacturing cost as well as reduce profile and form-factor of the completed module.

In addition, recall that with the conventional assemblies 100A, 100B, one primary purpose of the capping window 160 is for the protection of the optical sensor 110. But in an aspect, the lens assembly 200 of FIG. 2B may provide the same or even better protection for the imaging sensor 210 even without the capping window. As seen in FIG. 2B, an interior space 240 may be defined by the lens 220, the left and right spacers 230-L, 230-R and the imaging sensor 210. For the protection of the imaging sensor 210, the interior space 240 may be hermetically sealed.

In an aspect, hermetic sealing is more than a simple vacuum packaging. Sensor packages are often sealed to protect the sensor for optimum performance. In most instances, this means isolating the sensor from the ambient operating environment by providing the sensor with a controlled environment (e.g., a vacuum). However, if the controlled environment cannot be maintained, the performance of the sensor, and therefore the performance of the assembly, will likely degrade over time. Thus, to enable a long product lifetime (e.g., greater than 5 years, greater than 20 years, etc.), a high quality hermetic sealing is proposed for the lens assembly 200. For example, a hermeticity level less than 10⁻¹⁴ cc/sec may be provided.

Over time, the controlled environment (e.g., vacuum) may not be maintained due to any combination of leaks, permeation and outgassing. As a result, the operational performance lens assembly 200 may degrade. Leaks may be viewed as flow of contaminants (e.g., ambient gas) into the interior space 240 through unintentional openings. Leaks can be minimized through high quality bonding between the different components of the lens assembly 200, e.g., between the lens 220 and the spacers 230-L, 230-R, and between the imaging sensor 210 and the spacers 230-L, 230-R. Bonding techniques include metal-to-metal, eutectic, anodic, direct and glass frit.

Permeation may be viewed as diffusion of contaminants through a material. For example, contaminants may diffuse through the lens 220 and/or the spacers 230-L, 230-R into the interior space 240. Permeation may be minimized through selection of the materials for the components of the lens assembly 200, e.g., through selection of the materials for the lens 220, the spacers 230-L, 230-R, and/or the imaging sensor 210. For example, glasses, metals and metal oxides have lower permeabilities than epoxies and fluorocarbons. Permeation may also be minimized through design, e.g., by increasing the thicknesses of the spacers 230-L, 230-R or coating metallic layer on the surfaces of spacers as diffusion (permeation) barriers.

Outgassing may be viewed as a release of materials from surfaces thereof. Note that a lower surface of the lens 220 and inner side surfaces of the spacers 230-L, 230-R are exposed to the interior space 240. Materials of the lens 220 and/or the spacers 230-L, 230-R may be released, i.e., outgassed, into the interior space 240 from these exposed surfaces. Like permeation, outgassing may be minimized through selection of materials and/or through incorporating materials with gettering properties (more on this below).

The lens assembly 220 may be formed in consideration of factors described above as well as others (such as cost, ease of manufacture, etc.). In an aspect, for optical sensing applications (e.g., visible wavelengths), the lens 220 may be formed from glass, which is relatively inexpensive and has relatively small permeability. For thermal sensing applications (infrared (IR) wavelengths), the lens 220 may molded from a chalcogenide material. Of course, the lens 220 may be formed from a variety of materials (glass, chalcogenide, Si based, Ge based, Zn based, fluoride based, etc.). It is recognized that different materials may be preferred for sensing different wavelengths. Satisfactory hermetic seal can be provided when the thickness of the lens ranges between 500 μm to 1 mm.

The spacers 230-L, 230-R may also be formed a variety of materials. In an aspect, the spacers 230-L, 230-R may be formed low permeability materials such as glass, silicon nitride, metal and/or metal oxides. Alternatively, the spacers 230-L, 230-R may be formed from relatively high permeability materials (e.g., fluorocarbons, organic polymers, epoxies) with the inner sides of the spacers 230-L, 230-R coated with low permeability materials.

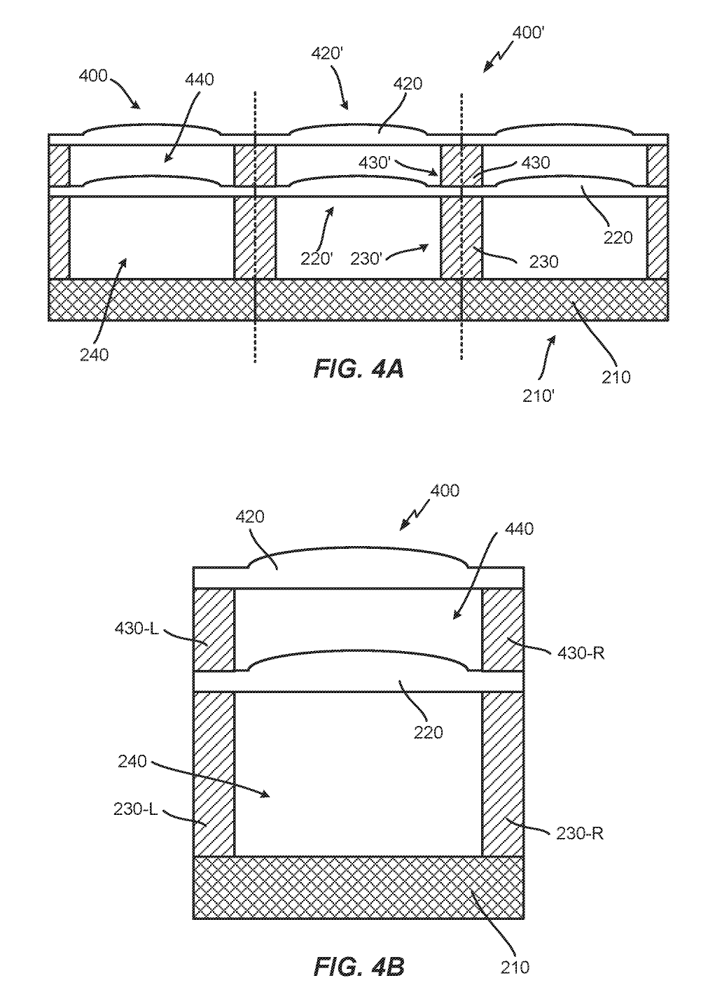

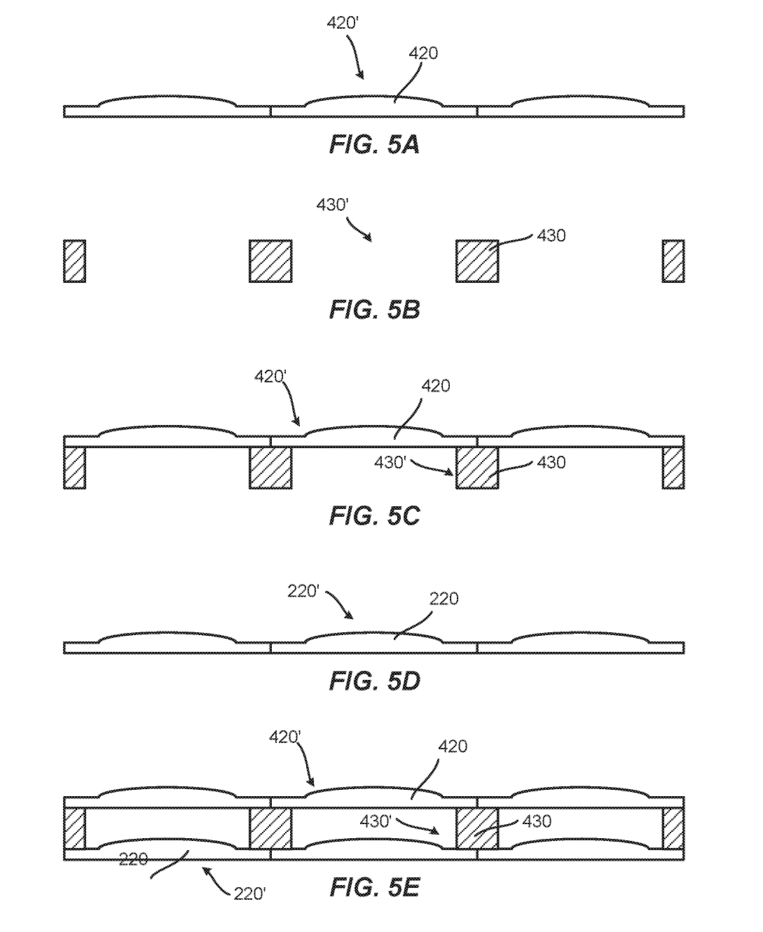

As indicated above, outgassing may be reduced through the selection of the materials for the lens 220 and/or the spacers 230. Another way to minimize outgassing is through gettering. For example, FIG. 3A illustrates a non-limiting example of a spacer 230, which may include a spacer support 332 and first and second getters 334-1, 334-2 (collectively a getter 334 or means for gettering) on both side surfaces of the spacer support 332. The spacer 230 of FIG. 3A may be one of the plurality of spacers 230 of the spacer array 230′ (see FIG. 2A) that can be individualized along the dashed individualization line. For convenience, the spacer support 332 is divided into first and second spacer supports 332-1, 332-2.

FIG. 3B illustrates an example of an individual lens assembly 200 resulting from individualizing the lens assembly array 200′ with the spacers 230 of FIG. 3A. The left and right spacers 230-L, 230-R may include individualized portions of adjacent spacers 230. As seen, the first and second getters 334-1, 334-2 may face the interior space 240, i.e., face the center of the imaging sensor 210 where the sensing portion is likely to be located. The first and second getters 334-1, 334-2 help in the adsorption of gases that may otherwise be outgassed into the interior space 240 from the first and second spacer supports 332-1, 332-2. The gettering process as well as the getters 334 on the surface of spacers 230 also provide the advantage of small form-factor or high fill factor because the getters 334 do not occupy any space in sensor area.

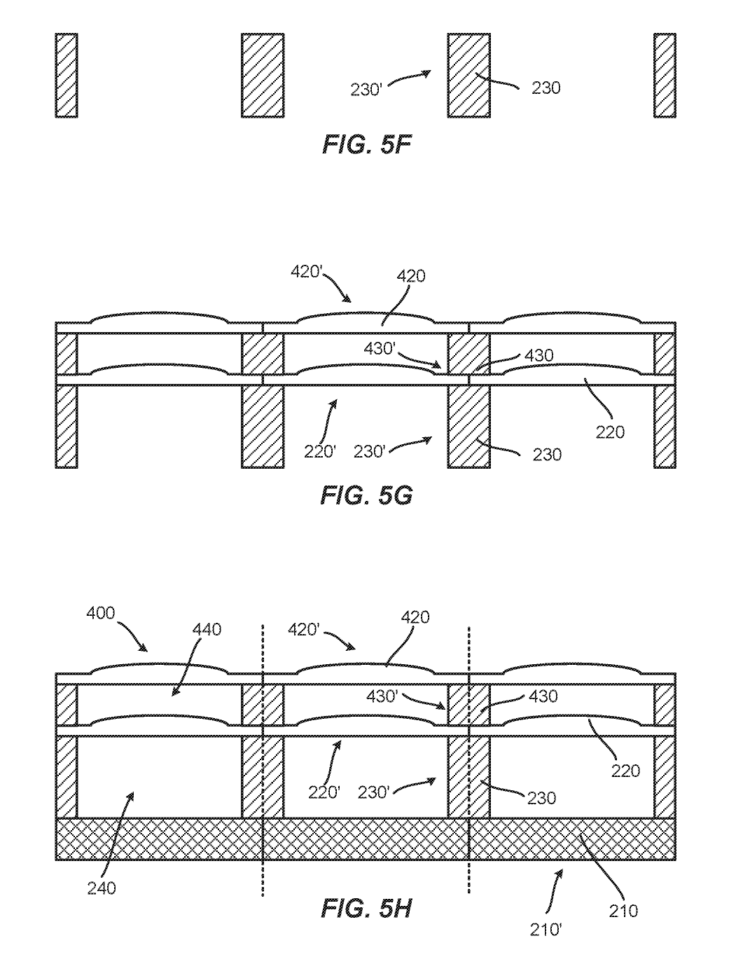

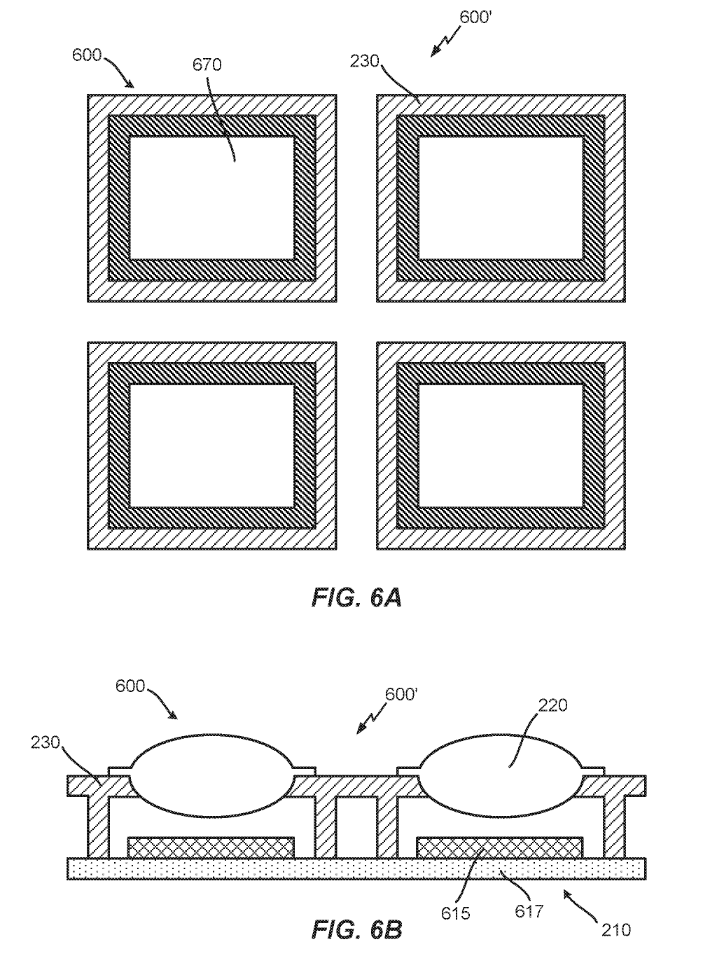

FIGS. 2A, 2B, 3A and 3B illustrate examples of lens assembly arrays and lens assemblies with one lens level. However, there can be any number of lens levels. FIG. 4A illustrate an example of a lens assembly array 400′ that includes two lens levels. The lens assembly array 400′ may be assumed to include similar components as the lens assembly array 200′ of FIG. 2A and thus will be numbered the same. For convenience, the spacer array 230′ will be referred to as the first spacer array 230′, and the lens array 220′ will be referred to as the first lens array 220′. The lens assembly array 400′ may additionally comprise a second spacer array 430′ above the first spacer array 230′, and a second lens array 420′ on the second spacer array 430′. The second spacer array 430′ may comprise a plurality of second spacers 430, and the second lens array 420′ may comprise a plurality of second lenses 420.

FIG. 4B illustrates an example of an individual lens assembly 400 that may result from individualizing the lens assembly array 400′ of FIG. 4A along individualization lines. Again, the left and right spacers 230-L, 230-R, the lens 220, and the interior space 240 will be prefixed with “first” for convenience. The lens assembly 400 may additionally comprise second left and right spacers 430-L, 430-R on the first left and right spacers 230-L, 230-R, and a second lens 420 on the second left and right spacers 430-L, 430-R. As seen, the first lens 220, the second left and right spacers 430-L, 430-R, and the second lens 420 may define a second interior space 440.

The first and second lenses 220, 420 may be shaped similarly or differently. For example, the first lens 220 may be shaped to diverge (e.g., concave) or to converge (e.g., convex) the incoming radiation. The second lens 420 may also be shaped to diverge or converge the incoming radiation. In addition, the heights of the first spacers 230-L, 230-R may be same or different from the heights of the second spacers 430-L, 430-R. Preferably, the shapes of the lens 220, 420 and the heights of the spacers 230, 430 are such that the incoming radiation is focused on the imaging sensor 210. The first and second lenses 220, 420 may be formed from same or different materials. Also, the first spacers 230-L, 230-R may be formed from same or different materials as the second spacers 430-L, 430-R.

Recall that hermetically sealing the first interior space 240 may be a significant consideration when choosing the materials for the first lens 220 and the first spacers 230-L, 230-R. However, hermetically sealing the second interior space 440 may be of significantly less concern. In such instances, the second lens 420 and/or the second spacers 430-L, 430-R may be formed from less costly materials relative to the first lens 220 and/or the first spacers 230-L, 230-R.

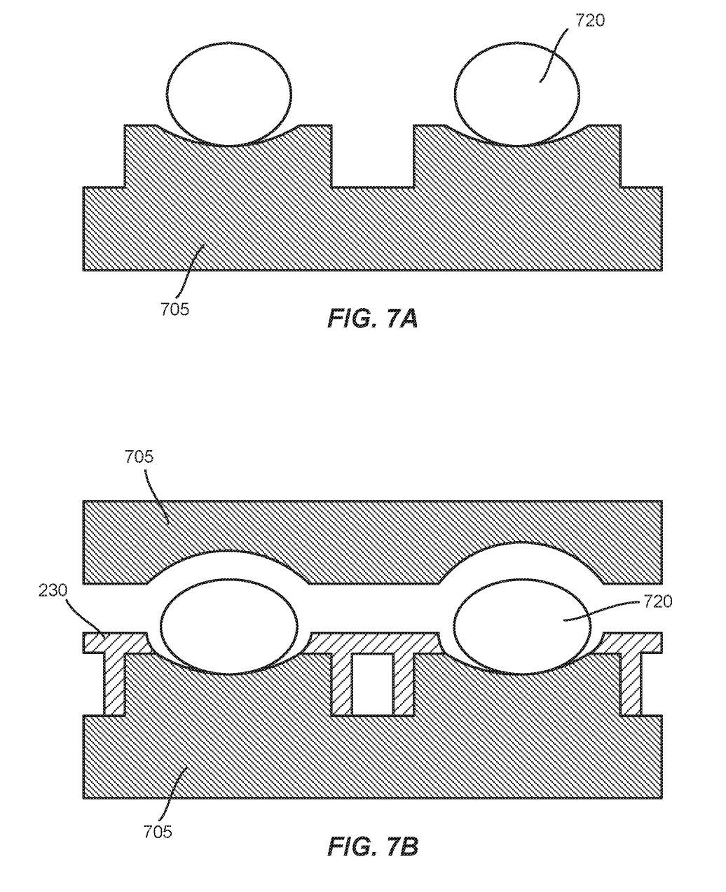

FIGS. 5A-5H illustrate examples of different stages of fabricating a lens assembly array. FIG. 5A illustrates a stage in which the second lens array 420′—the plurality of second lenses 420—may be formed. FIG. 5B illustrates a stage in which the second spacer array 430′—the plurality of second spacers 430—may be formed. FIG. 5C illustrates a stage in which the second lens array 420′ may be attached on the second spacer array 430′.

FIG. 5D illustrates a stage in which the first lens array 220′—the plurality of first lenses 220—may be formed. FIG. 5E illustrates a stage in which the first lens array 220′ may be attached to the second spacer array 430′. FIG. 5F illustrates a stage in which the first spacer array 230′—the plurality of first spacers 230—may be formed. FIG. 5G illustrates a stage in which the first spacer array 230′ may be attached to the first lens array 220′ and/or the second spacer array 430′.

FIG. 5H illustrates a stage in which the imaging sensor array 210′—the plurality of imaging sensors 210—may be formed and attached to the first spacer array 230′. Thereafter, the lens assembly array 400′ may be individualized, e.g., diced, into individual lens assemblies 400, an example of which is illustrated in FIG. 4B. While not shown, the imaging sensor array 210′ may be attached to the first spacer array 230′ in a controlled environment. In this way, after the attachment, the interior spaces 240 may maintain the controlled environment. For example, if a vacuum is desired, the environment may be evacuated prior to attaching the imaging sensor array 210′ to the first spacer array 230′.

If the lens assembly array 200′ of FIG. 2A is desired, then the stages illustrated in FIGS. 5A, 5B, 5C and 5E need not be performed. On the other hand, if further levels of lenses are desired, then the stages of similar to those of FIGS. 5A, 5B and 5C may be repeated as necessary. While not specifically shown, the spacers 230 illustrated in FIG. 5F may include getters 334.

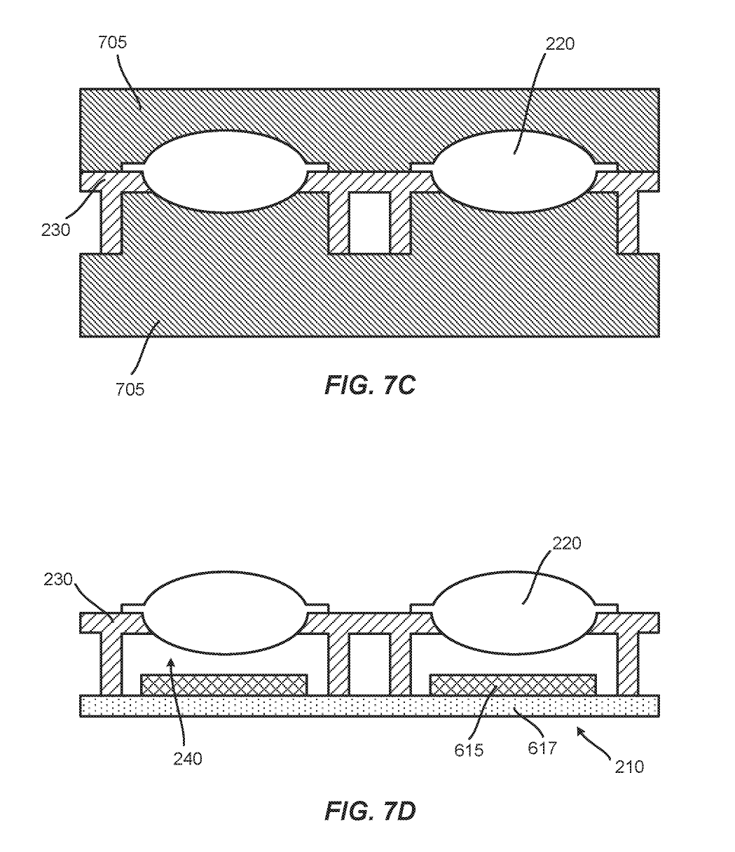

FIGS. 6A and 6B respectively illustrate views of another example of a lens array 600′ comprising a plurality of lens assemblies 600. A top view of four neighboring lens assemblies 600 are illustrated in FIG. 6A, and a side view two neighboring lens assemblies 600 are illustrated in FIG. 6B. For each lens assembly 600, the corresponding imaging sensor 210 may comprise an active portion 615 on a substrate 617. The active portion 615, which may comprise a sensor portion (e.g., FPA) and a circuit portion (e.g., ROIC) may be centered on the substrate 617 (e.g., glass, PCB). In FIG. 6A, active areas 670 may correspond to the areas of the active portions 615.

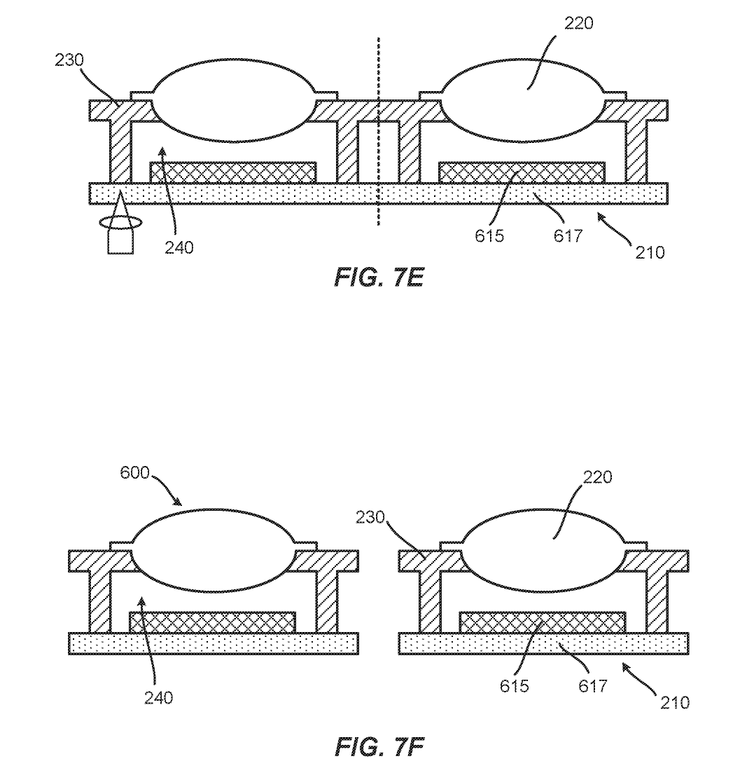

FIGS. 7A-7F illustrate examples of different stages of fabricating a lens assembly array 600′. FIG. 7A illustrates a stage in which a plurality of lens pellets 720 may be dispensed in a mold 705 (lower part shown). The lens pellets 720 may be amorphous (e.g., chalcogenide). The mold 705 may be a tungsten carbide mold or other similar metal mold.

FIG. 7B illustrates a stage in which the plurality of lens pellets 720 may be heated, e.g., above their glass transition (Tg) temperatures, to soften the lens pellets 720. Also, the plurality of spacers 230 may be aligned in the mold 205. The spacers 230 may be formed of glass.

FIG. 7C illustrates a stage in which the mold 705 (upper and lower parts) may press and hold the lens pellets 720 to shape the lens pellets 720 into the lenses 220. While the lens pellets 720 are being held, the temperature may be decreased, which solidify the lenses 220, and thus enable their shapes to be maintained. Significantly, the shaping the lens pellets 720 may also attach the lenses 220 to the spacers 230.

FIG. 7D illustrates a stage in which the lens array 220′ (the plurality of lenses 220) and the attached spacer array 230′ (the plurality of spacers 230) may be removed from the mold 705. Also, the imaging sensor array 210′ (the plurality of imaging sensors 210) may be formed. The spacer array 230′ may then be aligned on the imaging sensor array 210′ such that the plurality of lenses 220 are aligned with the active areas 670 (with the active portions 615).

FIG. 7E illustrates a stage in which the imaging sensor array 210′ may be attached to the first spacer array 230′. For example, the substrate 617 may be laser welded to the plurality of spacers 230. Thereafter, the lens assembly array 600′ may be individualized, e.g., diced, into individual lens assemblies 600 as seen in FIG. 7F. While not shown, laser welding may take place in a controlled environment such as in a vacuum. In this way, after the laser welding, the interior spaces 240 may maintain the desired controlled environment.

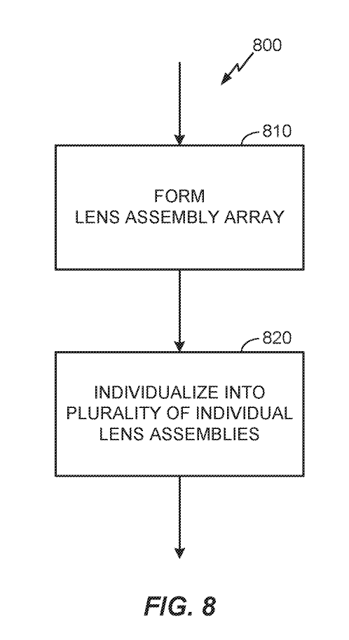

FIGS. 8, 9 and 10 illustrate flow charts of an example method 800 of fabricating a lens assembly. It should be noted that not all illustrated blocks of FIGS. 8, 9 and 10 need to be performed, i.e., some blocks may be optional. Also, the numerical references to the blocks of these figures should not be taken as requiring that the blocks should be performed in a certain order.

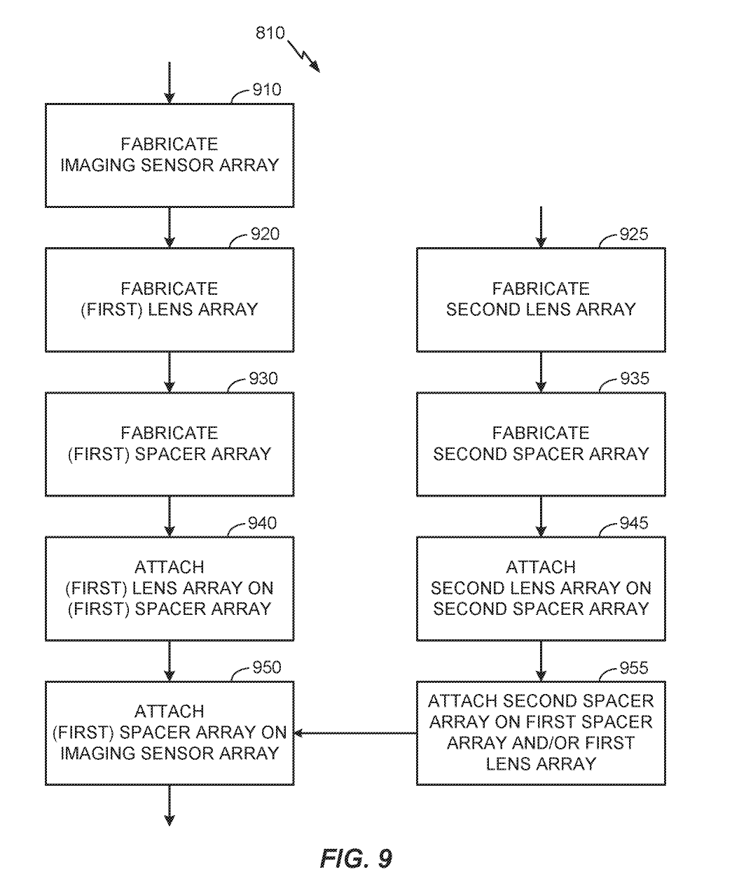

In block 810 of FIG. 8, a lens assembly array, such as any of the lens assembly arrays 200′, 400′, 600′ may be formed. FIG. 9 illustrates a flow chart of an example process of block 810. In block 910, the image sensor array 210′ may be fabricated. Block 910 may correspond to FIGS. 5H and 7D. In block 920, the lens array 220′ may be fabricated. Block 920 may correspond to FIGS. 5D and 7A-7C. In block 930, the spacer array 230′ may be fabricated. Block 930 may correspond to FIGS. 5F and 7B. In block 940, the lens array 220′ may be attached on the spacer array 230′. Block 940 may correspond to FIGS. 5G and 7C. In block 950, the spacer array 230′ may be attached on the imaging sensor array 210′. Block 950 may correspond to FIGS. 5H and 7D-7E. In an aspect, block 950 may be performed in a controlled environment. For example, the environment may be evacuated prior to attaching the spacer array 230′ on the imaging sensor array 210′.

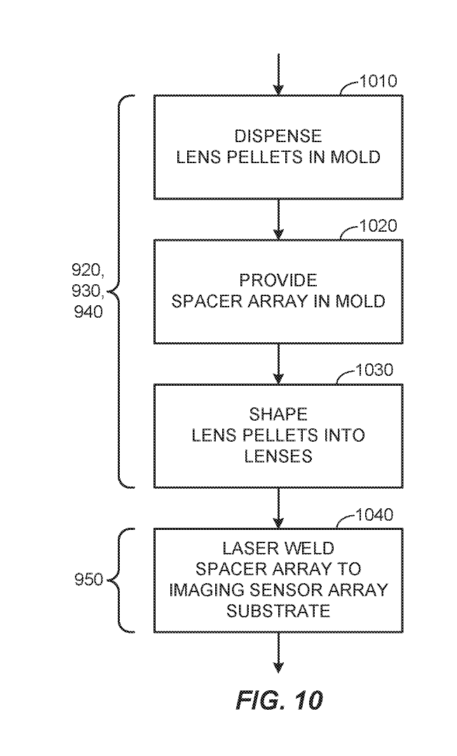

FIG. 10 illustrates a flow chart of example processes of blocks 920, 930, 940 and 950. In block 1010, the plurality of lens pellets 720 may be dispensed in the mold 705. Block 1010 may correspond to FIG. 7A. In block 1020, the spacer array 230′ may be provided in the mold 705. Block 1020 may correspond to FIG. 7B. In block 1030, the plurality of lens pellets 720 may be shaped into the plurality of lenses 220. In an aspect, the shaping the lens pellets 720 may also attach the lens array 220′ to the spacer array 230′. Block 1030 may correspond to FIG. 7C. In block 1040, the substrate 617 of the image sensor array 210′ may be attached to the spacer array 230′, e.g., through laser welding. Block 1040 may correspond to FIGS. 7D-7E.

If a single level of lenses is sufficient, then the method 800 may proceed to block 820 of FIG. 8 in which the lens assembly array may be individualized, e.g., diced into individual lens assemblies. However, if multiple levels are to be formed, then the method 800 may proceed to block 925 of FIG. 9 of fabricating the second lens array 420′. Block 925 may correspond to FIG. 5A. In block 935, the second spacer array 430′ may be fabricated. Block 935 may correspond to FIG. 5B. In block 945, the second lens array 420′ may be attached on the second spacer array 430′. Block 945 may correspond to FIG. 5C. In block 955, the second spacer array 430′ may be attached on the first spacer array 230′. Block 955 may correspond to FIG. 5G. Thereafter, the method 800 may proceed to block 820 of FIG. 8. If additional level(s) of lenses are desired, then processes similar to blocks 925, 935, 945, 955 may be performed as many times as necessary.

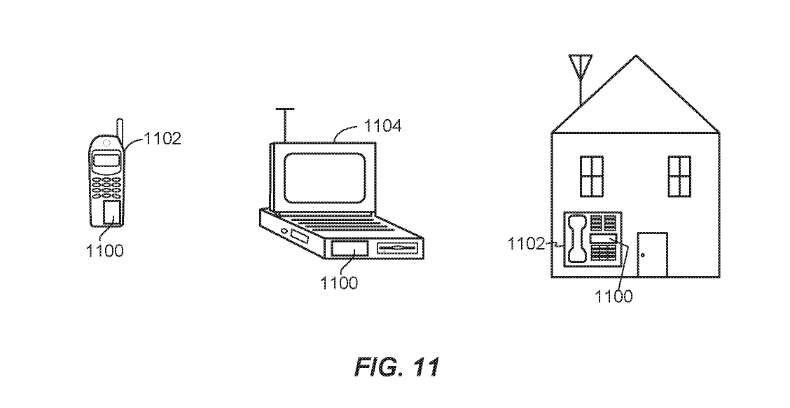

FIG. 11 illustrates various electronic devices that may be integrated with any of the aforementioned lens assemblies 200, 400, 600. For example, a mobile phone device 1102, a laptop computer device 1104, and a fixed location terminal device 1106 may include a device/package 1100 that incorporates the lens assemblies 200, 400, 600 as described herein. The device/package 1100 may be, for example, any of the integrated circuits, dies, integrated devices, integrated device packages, integrated circuit devices, device packages, integrated circuit (IC) packages, package-on-package devices described herein. The devices 1102, 1104, 1106 illustrated in FIG. 11 are merely exemplary. Other electronic devices may also feature the device/package 1100 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof

The following is a list (not necessarily exhaustive) of advantages of the proposed lens assemblies:
all processes performed in batch at wafer level or panel level;
incorporate optics in packaging;
low cost;
low optical absorption;
straight forward implementation with multiple lenses in system;
low profile and small form factor.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithms described in connection with the examples disclosed herein may be implemented as electronic hardware, computer software, or combinations of both. To clearly illustrate this interchangeability of hardware and software, various illustrative components, blocks, modules, circuits, and methods have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled with the processor such that the processor can read information from, and write information to, the storage medium. In the alternative, the storage medium may be integral to the processor.

Accordingly, an aspect can include a computer readable media embodying a method of forming a semiconductor device. Accordingly, the scope of the disclosed subject matter is not limited to illustrated examples and any means for performing the functionality described herein are included.

While the foregoing disclosure shows illustrative examples, it should be noted that various changes and modifications could be made herein without departing from the scope of the disclosed subject matter as defined by the appended claims. The functions, processes and/or actions of the method claims in accordance with the examples described herein need not be performed in any particular order. Furthermore, although elements of the disclosed subject matter may be described or claimed in the singular, the plural is contemplated unless limitation to the singular is explicitly stated.

What is claimed is:

1. A lens assembly, comprising:
an imaging sensor;
left and right spacers on the imaging sensor and spaced apart from each other; and
a lens on the left and right spacers,
wherein an interior space defined by the lens, the left and right spacers, and the imaging sensor is hermetically sealed.

2. The lens assembly of claim 1, wherein a hermeticity level of the interior space is less than 10⁻¹⁴ cc/sec.

3. The lens assembly of claim 1, wherein the lens is a glass lens.

4. The lens assembly of claim 1, wherein the lens is a chalcogenide lens.

5. The lens assembly of claim 1, wherein the left and right spacers are formed from one or more of a glass, metal, metal oxide, and silicon nitride.

6. The lens assembly of claim 1, wherein the left and right spacers comprise getters facing the interior space.

7. The lens assembly of claim 1,
wherein the lens and the left and right spacers are respectively a first lens and first left and right spacers, and
wherein the lens assembly further comprises:
second left and right spacers on the first left and right spacers; and
a second lens on the second left and right spacers.

8. The lens assembly of claim 1, wherein the lens assembly is one of a plurality of lens assemblies of a lens assembly array, the lens assembly array comprising:
an imaging sensor array comprising a plurality of imaging sensors, wherein the imaging sensor is one of the imaging sensors of the imaging sensor array;
a spacer array on the imaging sensor array, the spacer array comprising a plurality of spacers, wherein the left and right spacers are individualized portions of adjacent spacers of the spacer array; and
a lens array on the spacer array, the lens array comprising a plurality of lenses, wherein the lens is one of the lenses of the lens array.

9. The lens assembly of claim 1,
wherein the lens array and the spacer array are respectively a first lens array and a first spacer array, and
wherein the lens assembly array further comprises:
a second spacer array on the first spacer array, the second spacer array comprising a plurality of second spacers; and
a second lens array on the second spacer array, the second lens array comprising a plurality of second lenses.

10. The lens assembly of claim 1, wherein the lens assembly is incorporated into a device selected from a group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

11. A method, comprising:
forming a lens assembly array; and
individualizing the lens assembly array into a plurality of individual lens assemblies,
wherein each lens assembly, after individualizing the lens assembly array, comprises:
an imaging sensor;
left and right spacers on the imaging sensor and spaced apart from each other; and
a lens on the left and right spacers, and
wherein an interior space defined by the lens, the left and right spacers, and the imaging sensor is hermetically sealed.

12. The method of claim 11, wherein for each lens assembly, a hermeticity level of the interior spaces is less than 10⁻¹⁴ cc/sec.

13. The method of claim 11, wherein the lens assembly array, prior to individualizing, comprises:
an imaging sensor array comprising a plurality of imaging sensors;
a spacer array on the imaging sensor array, the spacer array comprising a plurality of spacers; and
a lens array on the spacer array, the lens array comprising a plurality of lenses,
wherein for each lens assembly of the lens assembly array,
the imaging sensor is one of the imaging sensors of the imaging sensor array,
the left and right spacers are individualized portions of adjacent spacers of the spacer array, and
the lens is one of the lenses of the lens array.

14. The method of claim 13, wherein forming the lens assembly array comprises:
fabricating the imaging sensor array;
fabricating the lens array;
fabricating the spacer array;
attaching the lens array on the spacer array; and
attaching the spacer array on the imaging sensor array.

15. The method of claim 14, wherein attaching the spacer array on the imaging sensor array occurs in a controlled environment.

16. The method of claim 14,
wherein the lens array is a first lens array comprising a plurality of first lenses,
wherein the spacer array is a first spacer array comprising a plurality of first spacers,
wherein forming the lens assembly array further comprises:
fabricating a second lens array comprising a plurality of second lenses;
fabricating a second spacer array comprising a plurality of second spacers;
attaching the second lens array on the second spacer array; and
attaching the second spacer array on the first spacer array.

17. The method of claim 14, wherein fabricating the lens array, fabricating the spacer array, and attaching the lens array on the spacer array comprise:
dispensing a plurality of lens pellets in a mold;
providing the spacer array in the mold; and
shaping the plurality of lens pellets into the plurality of lenses within the mold subsequent to providing the spacer array in the mold,
wherein shaping the plurality of lens pellets also attaches the plurality of lenses to the spacer array.

18. The method of claim 17, wherein attaching the spacer array on the imaging sensor array comprises laser welding the spacer array to a substrate of the image sensor array subsequent to shaping the plurality of lens pellets.

19. A lens assembly, comprising:
means for radiation sensing;
left and right means for spacing on the means for radiation sensing and spaced apart from each other; and
a lens on the left and right means for spacing,
wherein an interior space defined by the lens, the left and right means for spacing, and the means for radiation sensing is hermetically sealed.

20. The lens assembly of claim 19, wherein the left and right means for spacing comprise means for gettering facing the interior space.
